(19) United States
(12) Patent Application Publication
(10) Pub. No.: US 2015/0266629 A1
(43) Pub. Date: Sep. 24, 2015

(54) CORK STOPPER WITH RESIN COATING LAYER

(71) Applicants: UCHIYAMA MANUFACTURING CORP., Okayama-shi (JP); Suntory Holdings Limited, Osaka (JP)

(72) Inventors: Akihiro Anabuki, Okayama-shi (JP); Tatsuo Katayama, Akaiwa-shi (JP); Tomohisa Yamamoto, Okayama-shi (JP); Tatsuki Kado, Kawasaki-shi (JP); Shimpei Konishi, Tokyo (JP)

(21) Appl. No.: 14/662,140

(22) Filed: Mar. 18, 2015

(30) Foreign Application Priority Data
Mar. 19, 2014 (JP) 2014-055767

(51) Int. Cl. B65D 39/00; C09D 167/02; C09D 123/06

(52) U.S. Cl. CPC B65D 39/0011; C09D 123/06; C09D 167/02; B65D 2539/008

(57) ABSTRACT

A cork stopper is coated by a resin coating layer, having a columnar cork stopper body constituted with a molded cork body, and a resin coating layer covering an outer surface of the cork stopper body. The resin coating layer has a resin adhesion layer directly adhered onto the outer surface of the cork stopper body, and a resin layer adhered onto the outer surface of the cork stopper body with the resin adhesion layer interposed therebetween, and the resin coating layer on a circumferential face of the cork stopper body has a layer thickness from 100 to 240 μm.

### TECHNICAL FIELD

The present invention relates to a cork stopper with a resin coating layer for plugging the mouth portion of a container for beverages like whisky, brandy or wine.

### BACKGROUND ART

Referring to Patent Literature 1 to 4, a cork stopper coated with a resin layer, of which the outer surface of the cork stopper body is coated with resin, is widely used as a cork stopper for plugging the mouth portion of a container for beverages like whisky, brandy or wine. The cork stopper body of the cork stopper coated with the resin layer is formed in a columnar shape by compression molding cork granules and binder resin, or formed in the shape of a plug by boring natural cork bark. A resin coating layer is provided for preventing a corky smell from diffusing into the beverage in the container, preventing cork dust from falling into the container, preventing the discoloration of the cork surface caused by the seepage of the beverage into the cork layer, and the like.

Patent Literature 1 and 2 disclose that a cork stopper coated with a resin layer, wherein a coating layer of synthetic resin (for example, polyethylene, polypropylene or polyester) of 50 to 200 μm in thickness is formed on an outer surface of a cork stopper body, namely a stopper body including cork material. Patent Literature 3 discloses an adhesion layer adhered onto the outer surface of a cork stopper body, namely the insertion portion made of cork material and a cork stopper coated with a synthetic resin layer formed by adhering an outer layer made of polyethylene terephthalate resin onto an inner layer, the inner layer being made of polyethylene resin adhered onto the adhesion layer. Patent Literature 4 discloses a plug for a container, i.e. a cork stopper, coated with a synthetic resin layer formed by adhering, via a polyethylene resin adhesion layer, a synthetic resin layer made of polyester resin or mainly made of polyester resin onto a liquid contact face and an outer circumference continuously formed with the liquid-contact face of the core, i.e. a cork stopper body, constituted by an elastic body, i.e. cork.

### CITATION LIST

### Patent Literature

PTL 1 JP-2003-112114-A

PTL 2 JP-2003-117991-A

PTL 3 JP-2008-074448-A

PTL 4 WO2004/020300

### SUMMARY OF INVENTION

### Technical Problem

The above-mentioned cork stopper coated with the resin layer is preferably used for a container for beverages like whisky, brandy or wine, because the resin coating layer has the above-mentioned functions. On the other hand, it is pointed out that the resin coating layer sometimes generates wrinkles due to abrasion against the mouth portion of the container when the mouth portion of the container is plugged and the sealing ability is deteriorated, thus requiring improvement.

Patent Literature 1 and 2 do not disclose the prevention of wrinkles on the resin coating layer. Patent Literature 3 discloses that the outer layer made of polyethylene terephthalate resin is adhered without wrinkles onto the entire surface of the inner layer adhered onto the insertion portion, so that the liquid in the container does not directly contact the polyethylene resin constituting the inner layer. However, Patent Literature 3 does not mention wrinkles generated on the inner layer directly adhered onto the outer surface of the cork stopper body, specifically onto the inner layer of the circumferential face of the cork stopper body, when the mouth portion is plugged. In addition, Patent Literature 4, which is filed by the applicants of the present invention, discloses that wrinkles on the coating layer are prevented even when the core is constricted when the mouth portion of the container is plugged, because the core made of cork and the synthetic resin layer, coated on the outer surface of the core, are integrated by the interposed adhesion layer. However, upon examination by the inventors of the present invention, wrinkles are easily generated when the mouth portion is plugged, when the thickness of the resin coating layer, i.e. layer thickness, becomes thin, thereby requiring careful production control.

The present invention is proposed in view of the above-mentioned problems and has an object to provide a cork stopper with a resin coating layer capable of accurately preventing wrinkles on the resin coating layer when the mouth portion of the container is plugged, while maintaining the unique sealing ability and the special texture of the cork stopper.

### Solution to the Problem

A cork stopper with a resin coating layer of an embodiment of the present invention has a columnar cork stopper body constituted by a molded cork body and a resin coating layer covering an outer surface of the cork stopper body. The resin coating layer has a resin adhesion layer directly adhered onto the outer surface of the cork stopper body and a resin layer adhered onto the outer surface of the cork stopper body with the resin adhesion layer interposed therebetween. The resin coating layer on a circumferential face of the cork stopper body has a layer thickness from 100 to 240 μm.

In the above-mentioned cork stopper with the resin coating layer, the resin coating layer comprises the resin adhesion layer and the resin layer, so that the coating resin layer is firmly integrated with the cork stopper body by the resin adhesion layer. The layer thickness of the resin coating layer on the circumferential face of the cork stopper body is from 100 to 240 μm, thus the resin coating layer is unlikely to generate wrinkles when the cork stopper with the resin coating layer is plugged into the mouth portion of the container. If the layer thickness of the resin coating layer of the side circumferential face is less than 100 μm, the resin coating layer easily generates wrinkles during plugging, thus its sealing ability is likely to be deteriorated by the wrinkles. If the layer thickness of the resin coating layer of the side circumferential face exceeds 240 μm, the resin coating layer is unlikely to generate wrinkles. However, the cork stress is compromised by the resin coating layer, the conformability of the cork to the mouth portion of the container, which is a unique characteristic of the cork, is reduced and the unique sealing ability of cork is unlikely to be achieved. Specifically, there is variability in the diameters of the mouth portions when the containers are made of glass. The cork stopper conforms to different diameters resulting from this variability and achieves its sealing ability; however, if the thickness of the resin coating layer of the side circumferential face exceeds 240 μm, this conformability is likely to be compromised. In addition, this lowers the transparency of the resin coating layer, and the special texture and appearance of the cork is compromised, thereby reducing the retail value of the cork stopper.

In the cork stopper with the resin coating layer of an embodiment of the present invention, the molded cork body can be formed by compression molding cork granules and binder resin, and an average grain diameter of the cork granules can be from 0.5 to 3 mm.

In the above-mentioned cork stopper with the resin coating layer, the cork granules are bound to each other by binder resin and are molded under compression, thus the cork molded body is produced. The shape of the cork molded body is stabilized and the accumulated cork granules achieve unique elasticity. Therefore, the cork molded body is suitably plugged into or unplugged from the mouth portion of the container for beverages like whisky or brandy. The cork stopper body contains binder resin, so that the resin coating layer is firmly integrated with the cork stopper body by the resin adhesion layer. When the average grain diameter of the cork granules is from 0.5 to 3 mm and in addition, the layer thickness of the resin coating layer is from 100 to 240 μm, and the generation of wrinkles on the resin coating layer during plugging is effectively inhibited. If the average grain diameter of the cork granules is less than 0.5 mm, the unique elasticity of the cork granules resulting from the accumulated body is likely to be deteriorated. If the average grain diameter of the cork granules exceeds 3 mm, wrinkles are not inhibited. When the average grain diameter of the cork granules is from 0.5 to 1 mm, even if the cork is compressed during plugging, the resin coating layer is also uniformly compressed and wrinkles on the surface are invisibly scattered, thereby accurately preventing wrinkles by the synergetic effect with the above-specified range of the layer thickness of the resin coating layer. Specifically, if the layer thickness of the resin coating layer is outside the above-mentioned range, the wrinkle preventing effect on the resin coating layer is improved compared to a conventional embodiment when the average grain diameter of the cork granule is from 0.5 to 1 mm.

In the cork stopper with the resin coating layer of an embodiment of the present invention, the resin adhesion layer can be a polyethylene resin adhesion layer and the resin layer can be a polyethylene resin film layer.

In the above-mentioned embodiment, both the resin adhesion layer and the resin layer constituting the resin coating layer are made of polyethylene resin, thus the resin coating layer is accurately adhered to and integrated with the cork stopper body.

In the cork stopper with the resin coating layer of an embodiment of the present invention, the outer surface of the resin coating layer can be further coated with a polyethylene terephthalate resin layer.

In the above-mentioned embodiment, the outer surface of the resin coating layer is further coated with a polyethylene terephthalate resin with a high barrier property, thereby preventing the diffusion of a corky smell into the beverage liquid in the container. Polyethylene terephthalate is harmless and hygienic, thereby increasing its applicability to the cork stopper for beverages.

### ADVANTAGEOUS EFFECTS OF INVENTION

The present invention provides a cork stopper with a resin coating layer capable of preventing wrinkles on the resin coating layer when the mouth portion of the container is plugged, while maintaining the unique sealing ability and the special texture of the cork stopper.

### BRIEF DESCRIPTION OF DRAWINGS

FIG. 1 is a diagram of a longitudinal section showing one embodiment of a cork stopper with a resin coating layer of an embodiment of the present invention.

FIG. 2 is a diagram of a longitudinal section showing another embodiment of a cork stopper with a resin coating layer of the present invention.

FIG. 3 is a table with test results that show whether or not wrinkles were generated when the mouth portion of the container was plugged, when the thickness of the resin coating layer varied.

### DESCRIPTION OF EMBODIMENTS

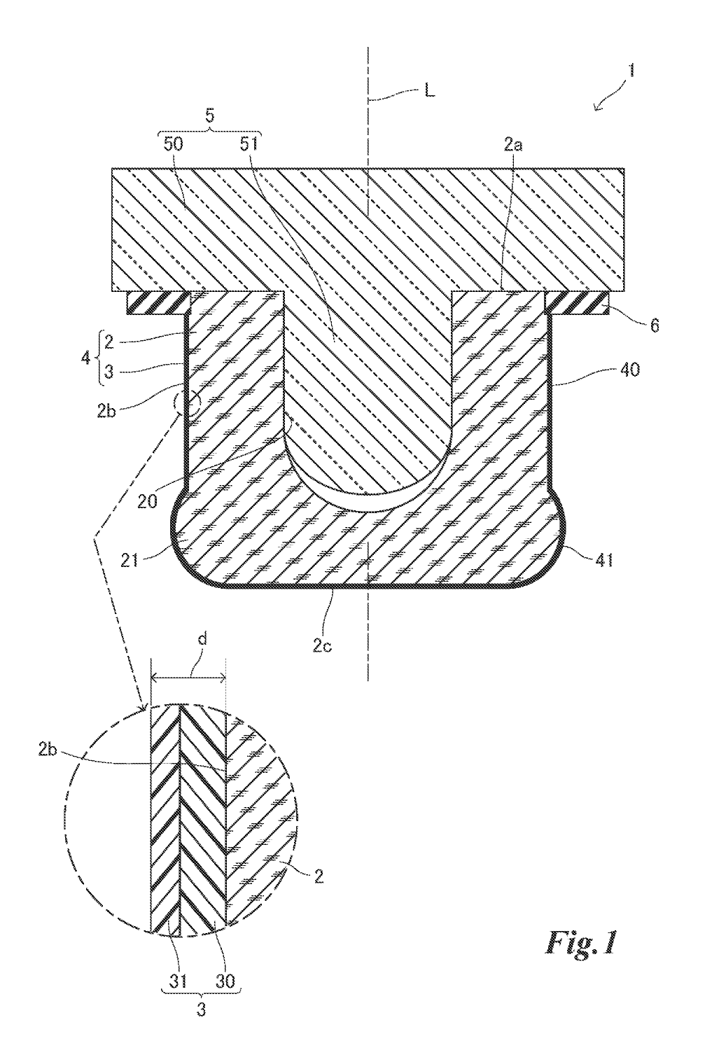

The embodiments of the present invention are explained referring to the attached drawings. FIG. 1 is a diagram of a longitudinal section showing one embodiment of a cork stopper with a resin coating layer of an embodiment of the present invention. A cork stopper with a resin coating layer 1 in the Figure comprises a columnar cork stopper body 2 formed by compression molding the cork granules and binder resin, i.e. a resin adhesive agent; a resin coating layer 3 coated on an outer surface of the cork stopper body 2 from an upper end 2a side along a circumferential face 2b and an lower end face 2c in the direction of an axis L; and a flange portion 5 integrated with the upper end portion 2a of the cork stopper body 2. The cork stopper body 2 and the resin coating layer 3 constitute a core portion 4. Cork granules are obtained by crushing and granulating natural cork bulk. The average grain diameter of the cork granules is from 0.5 to 3 mm, and preferably from 0.5 to 1 mm. The cork stopper body 2 is a columnar body formed by molding under compression in the centripetal direction and has an attachment hole 20 for attaching the flange portion 5 formed from the upper end portion 2a side to the lower end face 2c side along the direction of the axis L. The cork stopper body 2 in the Figure has a large-diameter portion 21 of which outer diameter is larger than those of the other portions of the cork stopper body 2, the large-diameter portion 21 being at a lower portion continuously formed from the lower end face 2c. The outer shape of the core portion comprises a columnar portion 40 and an expanding portion 41 continuously formed under the columnar portion 40 along the shape of the cork stopper body 2. The shape of the core portion 4, i.e. the cork stopper body 2, can be a straight columnar body without the expanding portion 41, i.e. the large-diameter portion 21.

The flange portion 5 is made of glass and comprises a disk-like flange body 50 and a columnar projecting portion 51 projecting downward from the center of the flange body 50. The projecting portion 51 is pressed into the attachment hole 20 of the cork stopper body 2 in such a manner that the lower face of the flange body 50 abuts the upper face of the cork stopper body 2. The abutting face and the pressed face are coated with an adhesive agent, and the cork stopper body 2 and the flange portion 5 are integrally fixed. A washer 6 made of polyethylene is fitted around the upper outer circumference of the cork stopper body 2 so as to contact the lower face of the flange portion 50. The washer 6 is provided between an upper open edge portion, not shown, of the mouth portion and the lower face of the flange portion 50 when the cork stopper body coated with the resin layer 1 is plugged by pressing the core portion 4 into the mouth portion of the container for whisky (not shown) . The washer 6 prevents the direct abutment of the open edge portion and the lower face of the flange body 50. The container made of glass does not contact the flange portion 5 made of glass and a consumer is able to plug the mouth portion without causing unpleasantness.

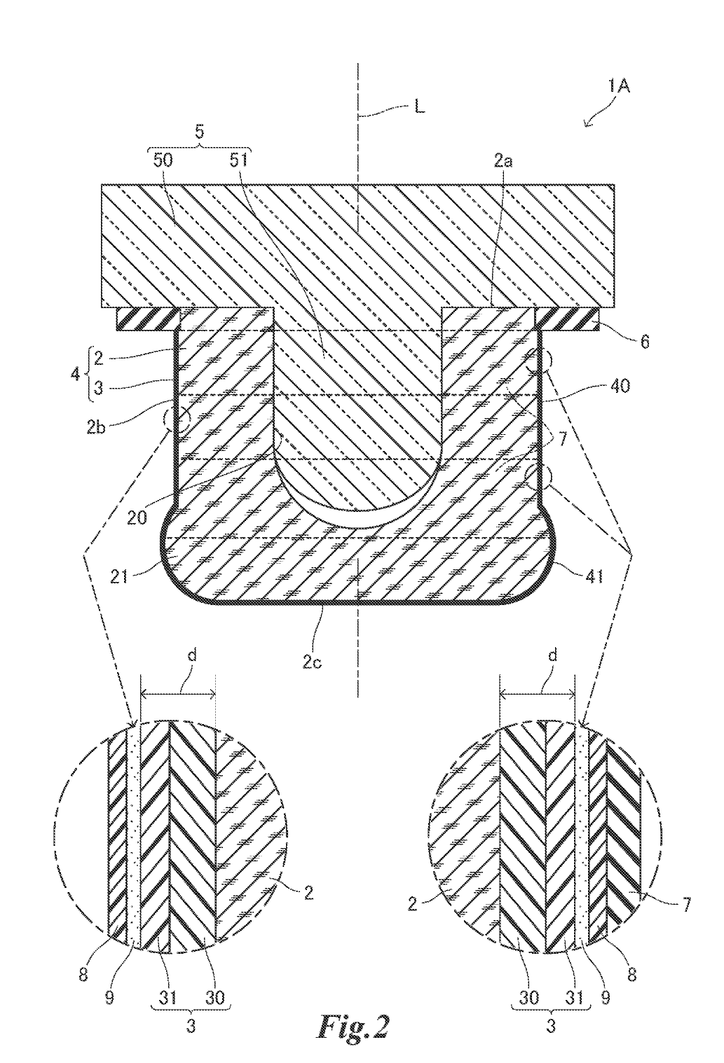

In the explanation referring to FIG. 1 and FIG. 2, the upper end portion 2a side is the upper side and the lower end face 2c side is the lower side. The flange portion 5 is made of glass in the above-mentioned embodiment; however, the flange portion 5 can be made of hard resin or metal.

The resin coating layer 3 comprises a resin adhesion layer 30 directly adhered onto the outer surface of the cork stopper body 2 and a resin layer 31 coated on the outer surface of the cork stopper body 2 with the resin adhesion layer 30 interposed. One desirable example of a combination of the resin adhesion layer 30 and the resin layer 31 constituting the resin coating layer 3 is a combination of a polyethylene resin adhesion layer and a polyethylene resin film layer. The present invention is not limited to such a combination and a combination of a polyester resin adhesion layer and a polyester resin film layer can be employed. In addition, other combinations are possible, such as a combination of a polyethylene resin adhesion layer and a polyester resin film layer, a combination of a polyester resin adhesion layer and a polyethylene resin film layer, a combination of another resin adhesion layer and another resin film layer, or the like.

The layer thickness “d” of the resin coating layer 3 is from 100 to 240 μm, and preferably from 120 to 200 μm. The resin coating layer 3 is integrally coated on the outer surface of the cork stopper body 2 as mentioned below. Firstly, a polyethylene adhesion film and a polyethylene film, which are overlapped, are placed on a mold (not shown) , having a cavity processed in conformity with the shape of the cork stopper body 2 with the polyethylene adhesion film placed upward. Next, a molded cork stopper body 2, prepared in advance, is pressed in the cavity of the mold together with the overlapped films from the lower end face 2c side, and the mold is heated to a predetermined temperature to melt the polyethylene adhesion film. When the polyethylene adhesion film is melted, the polyethylene adhesion film is heat-sealed on the polyethylene film and the outer surface of the cork stopper body 2. Thus, the polyethylene film is integrally coated on the outer surface of the cork stopper body 2 with the polyethylene adhesion film interposed. The cork stopper body 2 is taken out of the mold after being cooled, and the core portion 4 is obtained in such a manner that an outer surface of the core portion 4, including the circumferential face 2b and the lower end face 2c of the cork stopper body 2, is coated with the resin coating layer 3. The resin coating layer 3 comprises the resin adhesion layer 30, which is a polyethylene adhesion film directly adhered onto the outer surface of the cork stopper body 2, and the resin layer 31, which is a polyethylene film coated on the outer surface with the resin adhesion layer 30 interposed.

The thicknesses of the polyethylene adhesion film and the polyethylene film are selected in such a manner that the total thickness of the resin adhesion layer 30 and the resin layer 31, namely the layer thickness “d” of the resin coating layer 3, is between 100 and 240 μm. The total thickness of the resin adhesion layer 30 and the resin layer 31 can be from 100 to 240 μm, regardless of the relative relationship between the thickness of the resin layer 31 and the thickness of the resin adhesion layer 30. The forming method of the resin layer 31 includes a forming method in which resin powder is attached onto the outer surface of the cork stopper body 2 formed with the resin adhesion layer 30 and is also heat-melted, and a forming method that coats melted resin can also be utilized.

Then, the flange portion 5 is attached after the washer 6 is fitted at a predetermined position of the cork stopper body 2. The upper end face 2a, i.e. the upper end portion, of the cork stopper body 2 and the circumferential face of the projecting portion 51 of the flange portion 5 are applied with an adhesive agent, the projecting portion 51 is pressed into the attachment hole 20, and the adhesive agent is hardened, thereby attaching the flange portion 5. Thus, the cork stopper with the resin coating layer 1 as shown in the Figure, is obtained. The outer diameter of the columnar portion 40 of the core portion 4 of the cork stopper with the resin coating layer 1 is determined so as to have a tightening allowance of 1.5 mm relative to the inner diameter of the mouth portion of the container. The expanding portion 41 is formed by molding the cork stopper body 2 using a mold having a cavity in conformity with the shape of the cork stopper body 2 including the large-diameter portion 21, or the expanding portion 41 can be formed as follows. Using a mold with a cavity in the shape of a linear tube, the cork stopper body 2 is molded and the resin coating layer 3 is formed, then the expanding portion 41 is thermally expanded in the outer diametrical direction by heating the lower portion under the lower end portion of the attachment hole 20. The portion lower than the lower end portion of the attachment hole 20 is solid with accumulated cork granules, so that heat expansion works in the outer diametrical direction and the expanding portion 41 is formed as shown in the Figure.

The cork stopper with the resin coating layer 1, as mentioned above, is plugged into the mouth portion of the container for whisky, brandy or the like. The cork stopper with the resin coating layer 1 is pressed into the mouth portion of the container in such a manner that the expanding portion 41 of the core portion 4 is compressed in the centripetal direction and passes through the mouth portion, and the washer 6 abuts the open edge portion of the mouth portion; thus, the mouth portion is plugged with the cork stopper with the resin coating layer 1. In such a plugged condition, the columnar portion 40 of the core portion 4 is compressed in the centripetal direction by the length of the tightening allowance and elastically contacts the inner diametrical portion of the mouth portion. Thus, the mouth portion is sealed, the beverage in the container is prevented from leaking and outside air is prevented from entering the container. The lower end face 2c of the cork stopper body 2 becomes a liquid-contact face, but the lower end face 2c, coated with the resin coating layer 3, does not contact the beverage, and a corky smell is prevented from diffusing into the beverage in the container. In addition, cork dust is prevented from falling into the container and the cork surface is protected from discoloration by preventing the seepage of the beverage into the cork layer. The cork stopper with the resin coating layer 1 is plugged into the mouth portion in such a manner that the expanding portion 41 passes through the mouth portion, so that the cork stopper coated with the resin layer 1 is unlikely to be popped up. The layer thickness of the resin coating layer 3 is from 100 to 240 μm, thereby preventing wrinkles on the resin coating layer 3 during plugging and preventing any leakage of the beverage through the wrinkles when the container is inclined. In addition, in the embodiment of the present invention, the lower end face 2c of the cork stopper body 2 is coated with the thick resin coating layer 3, so that pinholes are not caused on the lower end face 2c and countermeasures against pinholes, which have been conventionally necessary, are not required. Thus, the production procedure of the cork stopper with the resin coating layer 1 can be simplified.

In the above-mentioned range of the layer thickness of the resin coating layer 3, the cork stress, namely elasticity, is not compromised, conformability to the mouth portion of the container, which is a unique characteristic of the cork, is stabilized, and there are no concerns about any changes to the sealing ability due to variability in the diameters of the mouth portions. In addition, the transparency of the resin coating layer 3 does not drop, and the special texture of the cork stopper is not compromised. When the average grain diameter of the cork granules is between 0.5 and 3 mm, wrinkles are effectively prevented during plugging, coupled with the effect by the above-mentioned characteristic of the layer thickness range of the resin coating layer 3. Specifically, when the average grain diameter of the cork granules is from 0.5 to 1 mm, even if the cork is compressed during plugging, the resin coating layer 3 is uniformly compressed and the wrinkles on the surface are invisibly scattered, thereby accurately preventing wrinkles by the synergetic effect of the above-specified range of the layer thickness of the resin coating layer 3.

In the embodiment of the present invention, the resin coating layer 3 within the above-mentioned layer thickness range is integrally coated with a substantially uniform thickness on the entire cork stopper body 2, including the circumferential face 2b and the lower end face 2c. However, at least the layer thickness of the circumferential face 2b to which abrasion stress is applied during plugging is within the above-mentioned range. The lower end face 2c is the liquid-contact face, so that the layer thickness of the lower end face 2c can be determined separately so as to prevent any interactions between the beverage and the cork.

FIG. 2 shows another embodiment of a cork stopper with a resin coating layer of the present invention. A cork stopper with a resin coating layer 1A of the embodiment is formed by coating a polyethylene terephthalate resin film 8 onto the outer surface of the resin coating layer 3 of the above-mentioned cork stopper with the resin coating layer 1. Specifically, the polyethylene terephthalate resin film 8 is integrally coated onto the outer surface of the resin coating layer 3 with a urethane adhesion layer 9 interposed. The polyethylene terephthalate resin film 8 is formed by the following method. For example, a urethane adhesive agent is applied onto the outer surface of the cork stopper body 2, i.e. the core portion 4, coated with the resin coating layer 3. Then, a heated polyethylene terephthalate resin film is coated onto the outer surface, pressed into a mold, and heat-sealed onto the outer surface with the polyethylene terephthalate film stretched, thereby forming the polyethylene terephthalate resin film 8 of polyethylene terephthalate adhered all over the outer surface of the resin coating layer 3. Polyethylene terephthalate is preferably used as resin for the polyethylene terephthalate resin film 8 when the container is used for beverages, because polyethylene terephthalate has a superior barrier performance, prevents the diffusion of a corky smell into the beverage liquid in the container, and is harmless and hygienic.

In the embodiment, two silicone elastomer layers 7 are provided. Each respective silicone elastomer layer 7 is integrally coated on the upper portion and the lower portion of the circumferential face 2b, except for the middle portion, in the circumferential direction, the upper portion and the lower portion being on the circumferential face 2b of the outer surface of the polyethylene terephthalate resin film 8 and being spaced in the axial direction L. The silicone elastomer layer 7 preferably includes a resin lubricant such as spherical silicone resin lubricant, a spherical polyethylene resin lubricant or inorganic lubricant such as silica, clay or talc. The silicone elastomer layers 7 function to facilitate the smooth plugging and unplugging of the cork stopper with respect to the resin coating layer 1A and the mouth portion of the container, and to prevent noise during plugging and unplugging. Therefore, a consumer is able to comfortably plug or unplug.

Also in the cork stopper with the resin coating layer 1A, the layer thickness “d” of the resin coating layer 3 is from 100 to 240 μm, thereby preventing wrinkles on the resin coating layer 3 when the mouth portion of the container is plugged, and preventing any leakage of the beverage through the wrinkles when the container is inclined. In addition, the polyethylene terephthalate resin film 8 is integrally coated all over the outer surface of the resin coating layer 3, and the lower end face 2c of the cork stopper body 2 does not contact the beverage, thereby preventing a corky smell from diffusing into the beverage in the container. In addition, cork dust is prevented from falling into the container, and the cork surface is protected from discoloration by preventing the beverage from seeping into the cork layer. The polyethylene terephthalate resin film 8, which is harmless, hygienic, has a superior barrier performance and prevents a corky smell from diffusing into the beverage liquid in the container, is provided on the liquid contact face, thereby increasing the applicability of the cork stopper to beverages.

Other structures, functions and effects of the above embodiments are the same as those of the cork stopper with the resin coating layer 1. Thus, a description of the common members, which have the same reference numerals, will be omitted.

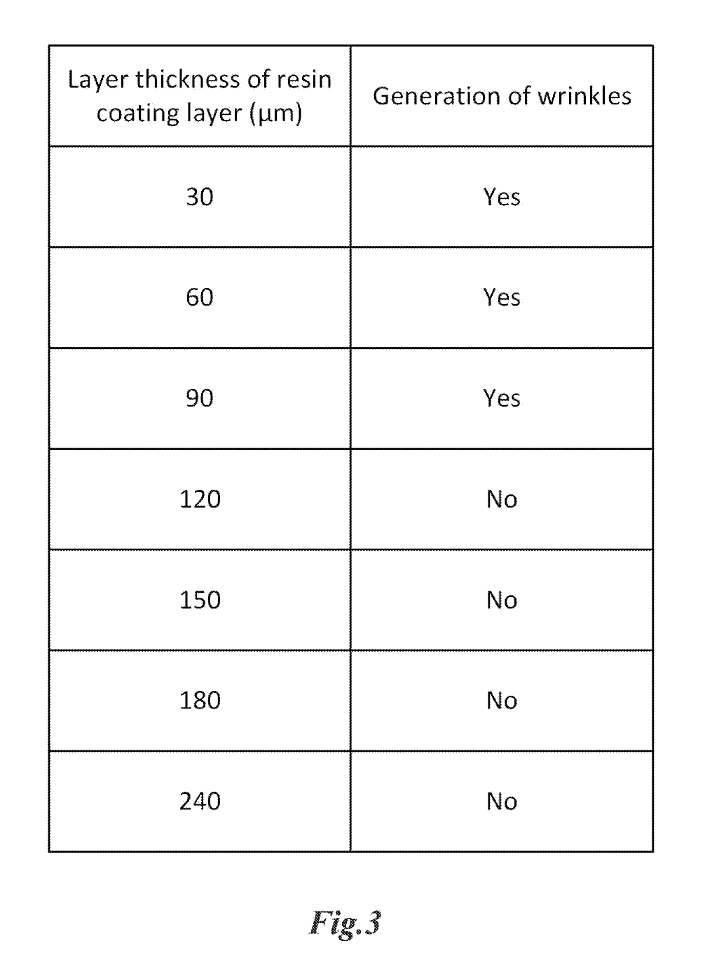

FIG. 3 indicates test results showing whether or not wrinkles are generated when the cork stopper with the resin coating layer 1A in FIG. 2 is plugged into the mouth portion of the container at various layer thicknesses of the resin coating layer. During the examination of the wrinkles, cork stoppers coated with different resin layers, varying the layer thicknesses of the resin coating layers 3, are prepared and are unplugged after being plugged into the mouth portion of the beverage container made of glass. Then the surface of the cork stopper with the resin coating layer is visually observed and the existence of wrinkles is confirmed. For evaluating the significance, the cork stopper with the resin coating layer is configured with a large tightening allowance to the mouth portion of the beverage container made of glass. In such a case, FIG. 3 shows that wrinkles are generated when the layer thickness “d” is smaller than 90 μm, and wrinkles are not generated when the layer thickness “d” is larger than 120 μm. When the layer thickness “d” is 90 μm, one wrinkle is found. It is understood that a layer thickness “d” of 100 μm or above is effective in preventing wrinkles.

In the above-mentioned embodiments, the cork stopper with the resin coating layer is used for a container for whisky, brandy or wine. The container can also be used for beverages such as champagne, Japanese sake or juice. The shapes of the cork stoppers with resin coating layers 1, 1A in FIG. 1 and FIG. 2 are examples, and the embodiments of the present invention are not limited to such shapes. In the embodiment, the cork stopper has the flange portion 5. However, the flange portion 5 may not be provided, or another member can be used instead of the flange portion 5 as long as the core portion 4, constituted by the cork stopper body 2 and the resin coating layer 3, is included. In the above-mentioned embodiments, the cork stopper body 2 is constituted by a molded body formed by the compression molding of cork granules and binder resin. However, the present invention is not limited to such embodiments, and the cork stopper body 2 can be constituted by a molded cork body formed by another method. The compression molding is not limited to be compressed in the diametrical direction. The compression can be in a direction along the axis L. In addition, the cork stopper with the resin coating layer 1 shown in FIG. 1 can be provided with a silicone elastomer layer 7 integrally coated on the upper portion and the lower portion of the circumferential face 2b, except for the middle portion in the circumferential direction, the upper portion and the lower portion being on the outer surface of the resin coating layer 3, namely the outer surface of the resin layer 31 of polyethylene film, and being provided with a space in the axial direction L.

### REFERENCE CHARACTERS LIST

1, 1A cork stopper with resin coating layer
2 cork stopper body
2b circumferential face
3 resin coating layer
30 resin adhesion layer
31 resin layer
8 polyethylene terephthalate resin film
d layer thickness

1. A cork stopper with a resin coating layer, comprising: a columnar cork stopper body constituted by a molded cork body, and the resin coating layer covering an outer surface of the cork stopper body, the resin coating layer comprising a resin adhesion layer directly adhered onto the outer surface of the cork stopper body, and a resin layer adhered onto the outer surface of the cork stopper body with the resin adhesion layer interposed therebetween, and the resin coating layer on a circumferential face of the cork stopper body having a layer thickness from 100 to 240 μm.

2. The cork stopper with the resin coating layer as set forth in claim 1, wherein the molded cork body is formed by compression molding cork granules and binder resin, and an average grain diameter of the cork granules is from 0.5 to 3 mm.

3. The cork stopper with the resin coating layer as set forth in claim 2, wherein the average grain diameter of the cork granules is from 0.5 to 1 mm.

4. The cork stopper with the resin coating layer as set forth in claim 1, wherein the resin adhesion layer is a polyethylene resin adhesion layer and the resin layer is a polyethylene resin film layer.

5. The cork stopper with the resin coating layer as set forth in claim 1, wherein an outer surface of the resin coating layer is further coated with a polyethylene terephthalate resin layer.

6. The cork stopper with the resin coating layer as set forth in claim 2, wherein the resin adhesion layer is a polyethylene resin adhesion layer and the resin layer is a polyethylene resin film layer.

7. The cork stopper with the resin coating layer as set forth in claim 3, wherein the resin adhesion layer is a polyethylene resin adhesion layer and the resin layer is a polyethylene resin film layer.

8. The cork stopper with the resin coating layer as set forth in claim 2, wherein an outer surface of the resin coating layer is further coated with a polyethylene terephthalate resin layer.

9. The cork stopper with the resin coating layer as set forth in claim 3, wherein an outer surface of the resin coating layer is further coated with a polyethylene terephthalate resin layer.

10. The cork stopper with the resin coating layer as set forth in claim 4, wherein an outer surface of the resin coating layer is further coated with a polyethylene terephthalate resin layer.
